(19) United States
(12) Patent Application Publication
(10) Pub. No.: US 2006/0158286 A1
(43) Pub. Date: Jul. 20, 2006

(54) Defected ground structure for coplanar waveguides

(76) Inventors: Yeong-Lin Lai, Sindian City (TW); Chih-Hong Chang, Yuanlin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,357

(22) Filed: Jan. 17, 2006

(30) Foreign Application Priority Data
Jan. 19, 2005 (TW) 094101591

(51) Int. Cl. H01P 3/08

(52) U.S. Cl. 333/238

(57) ABSTRACT

A defected ground structure for coplanar waveguides comprises two ground planes and one wire positioning between two ground planes. A gap is between each ground plane and the wire, respectively. Each ground plane is symmetrical to the other, and has at least one defected structure. More, each defected structure includes at least two parallel guide channels. One of the guide channels is connected with the gap. Further, each guide channel is connected with other through a connection channel. The defected structure for coplanar waveguides itself has a resonant characteristic. More, it forms a parallel equivalent circuit with multiple capacitors and inductors. In the same impedance, the present invention can efficiently reduce the area of the defected structure. Further, it can obtain a passband-stopband characteristic, a leaky-wave characteristic, and a slow-wave characteristic.

### BACKGROUND OF THE INVENTION

The present invention is related to a structure having coplanar waveguides. More particularly, it relates to the defected ground structure for coplanar waveguides having a parallel equivalent circuit with multiple capacitors and inductors.

Please refer to FIG. 5. It shows a conventional defected ground structure for coplanar waveguides (hereinafter refer to as “DGSCPW”). More, it shows that the substrate (80) made of a dielectric material has two ground planes (81 and 82) and a wire (83) for forming coplanar waveguides. A gap is individually formed between each ground plane (81 and 82) and the wire. Further, each ground plane (81 and 82) forms a defected structure (85 and 86) by an etching method.

In the above defected ground structure for coplanar waveguides, the wire (83) is used to transmit the signal, and the defected structure (85 and 86) forms an equivalent impedance load effect.

However, the above defected structure (85 and 86) forms as a rectangular shape. If the impedance is required to increase, the width and the height of the defected structure (85 and 86) should be adjusted. Theoretically, the ground plane of the coplanar waveguide is a semi-infinite ground plane, and the size by enlarging the defected structure (85 and 86) does not have any problem. However, the defected structure (85 and 86) only can adjust height and width, and flexibility for adjustment is insufficient. Therefore, the above defected ground structure for coplanar waveguides should be improved.

### SUMMARY OF THE INVENTION

The main object of the present invention is to solve the above problems, and further to provide a defected ground structure for coplanar waveguides. Each ground plane in the structure for the coplanar waveguides is symmetrical to the other, and has at least one defected structure. More, each defected structure includes at least two parallel guide channels. One of the guide channels is connected with the gap of the coplanar waveguide, and each guide channel is connected with other through a connection channel. Therefore, the structure for coplanar waveguides itself has a resonant characteristic. In the same impedance, the present invention can efficiently reduce the area of the defected structure. Further, it can obtain a passband-stopband characteristic, a leaky-wave characteristic, and a slow-wave characteristic.

One of the objects in the present invention is to adjust the total width and the total height of the defected structure, the width of the guide channel, and the height of the connection channel. It can change resonant frequency, capacitance, inductance, leaky-wave frequency, and stopband center frequency as well as enhance flexibility of adjustment.

In order to achieve the above purpose, the present invention comprises two ground planes and one wire positioning between two ground planes for forming a structure of coplanar waveguides. A gap is between each ground plane and the wire, respectively. Each ground plane is symmetrical to the other, and has at least one defected structure. More, each defected structure includes at least two parallel guide channels. One of the guide channels is connected with the gap. Further, each guide channel is connected with other through a connection channel.

The present invention can be best understood through the following description and accompanying drawings wherein:

### BRIEF DESCRIPTION OF THE DRAWINGS

FIG. 1 shows the structure of the present invention;

FIG. 2 shows an equivalent circuit model of the present invention;

FIG. 3 shows a simplified model of the equivalent circuit in the present invention;

FIG. 4 is the 2^{nd} preferred embodiment showing the structure of the present invention; and

FIG. 5 shows a prior defected ground structure for coplanar waveguides;

FIG. 6 shows the full-wave simulations by S parameters in the present invention;

FIG. 7 shows the parameters of the total width change (W) in the present invention;

FIG. 8a shows the total width change (W) versus S₁₁ full-wave simulation in the present invention;

FIG. 8b shows the total width change (W) versus S₂₁ full-wave simulation in the present invention;

FIG. 8c shows the total width change (W) versus capacitance in the present invention;

FIG. 8d shows the total width change (W) versus inductance in the present invention;

FIG. 9 shows the parameters of the total height change (H) in the present invention;

FIG. 10a shows the total height change (H) versus S₁₁ full-wave simulation in the present invention;

FIG. 10b shows the total height change (H) versus S₂₁ full-wave simulation in the present invention;

FIG. 10c shows the total height change (H) versus capacitance in the present invention;

FIG. 10d shows the total height change (H) versus inductance in the present invention;

FIG. 11 shows the parameters of the width change (Wc) of the middle guide channel in the present invention;

FIG. 12a shows the width change (Wc) of the middle guide channel versus S₁₁ full-wave simulation in the present invention;

FIG. 12b shows the width change (Wc) of the middle guide channel versus S₂₁ full-wave simulation in the present invention;

FIG. 12c shows the width change (Wc) of the middle guide channel versus capacitance in the present invention;

FIG. 12d shows the width change (Wc) of the middle guide channel versus inductance in the present invention;

FIG. 13 shows the parameters of the width change (Wg) of the guide channel in the present invention;

FIG. 14a shows the width change (Wg) of the guide channel versus S₁₁ full-wave simulation in the present invention;

FIG. 14b shows the width change (Wg) of the guide channel versus S₂₁ full-wave simulation in the present invention;

FIG. 14c shows the width change (Wg) of the guide channel versus capacitance in the present invention;

FIG. 14d shows the width change (Wg) of the guide channel versus inductance in the present invention;

FIG. 15 shows the parameters of the height change (Hg) in the present invention;

FIG. 16a shows the height change (Hg) versus S₁₁ full-wave simulation in the present invention;

FIG. 16b shows the height change (Hg) versus S₂₁ full-wave simulation in the present invention;

FIG. 16c shows the height change (Hg) versus capacitance in the present invention;

FIG. 16d shows the height change (Hg) versus inductance in the present invention.

### DETAILED DESCRIPTION OF THE PREFERRED EMBODIMENTS

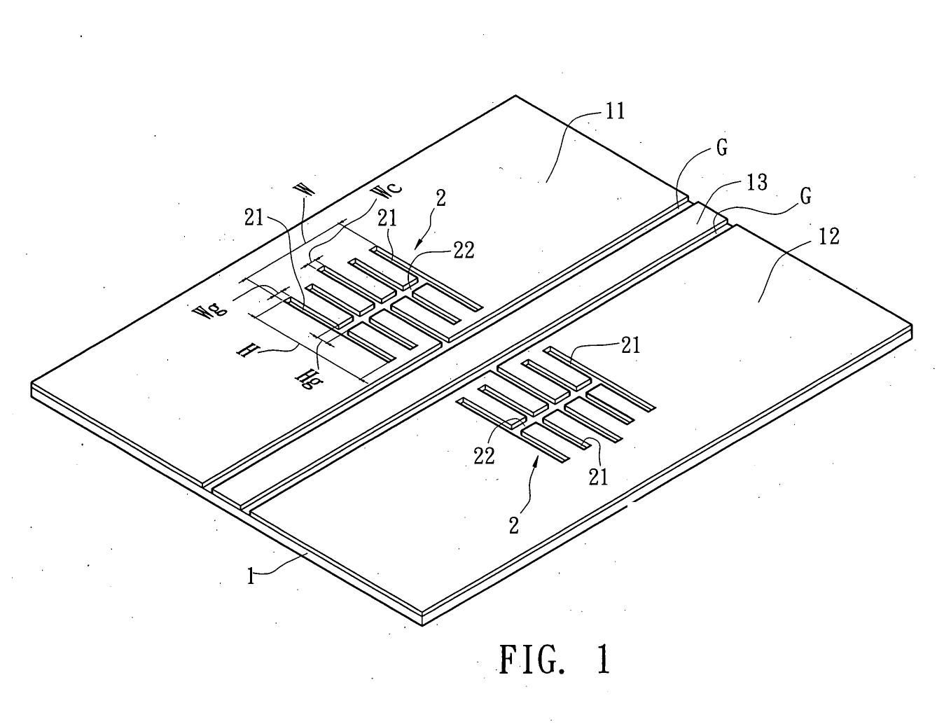

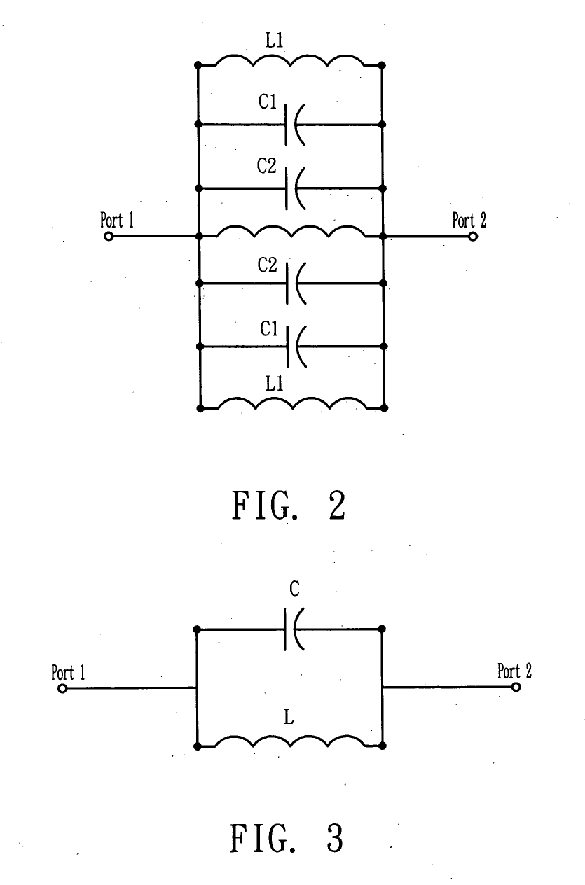

Please refer to FIGS. 1 to 4. The embodiments from the figures are only used to illustrate the present invention, not intended to limit the scope thereof.

The defected ground structure for coplanar waveguides in the preferred embodiments of the present invention comprises two ground planes (11 and 12) and a wire (13) positioning on the substrate which is made of dielectric or semiconductor material. A gap (G) is individually formed between each ground plane (11 and 12) and the wire (13). Each ground plane (11 and 12) in the structure for the coplanar waveguides is symmetrical to the other, and has at least one defected structure (2). Each defected structure (2) includes at least two parallel guide channels (21). One (21) of the guide channels is connected with the gap (G), and each guide channel (21) is connected with other through a connection channel (22). In the preferred embodiments, each defected structure (2) all has five guide channels (21). Besides, the guide channel (21) arranged in the middle vertically intersects with the gap (G). More, the connection channel (22) is positioned in the middle section of each guide channel (21), and vertically intersects with each guide channel (21).

The defected structure (2) of the present invention comprises multiple guide channels (21). One (21) of the guide channels is connected with the gap (G), and each guide channel (21) is connected with other through a connection channel (22). Therefore, the whole defected structure (2) forms a branched structure. Figure shows an equivalent circuit model corresponding to the defected ground structure for coplanar waveguides in the present invention. It can form an equivalent circuit with multiple parallel capacitors and inductors, and the simplified circuit can be seen from FIG. 3. In the comparison of the equivalent circuit between the present invention and the prior art, the defected ground structure for coplanar waveguides of the present invention can effectively reduce the area of the defected structure under the same impedance.

After conducting the research, the inventors have found that the circuit characteristic of the equivalent circuit is affected while each size of the defected structure is adjusted. More, the defected structure of the present invention has processed the full-wave electromagnetic simulations as well as disclosed the effects of the circuit. In order to illustrate the defected structure of the present invention, the name of each size is further defined as shown in FIG. 1. The distance across the parallel guide channels (21) is defined as the total width (W). The width of the guide channel is defined as Wg, the gap between each ground plane and each wire is defined as G, and the width of the middle guide channel is defined as Wc. The length of the guide channel is defined as the total height (H), and the length of the connection channel is defined as the height (Hg).

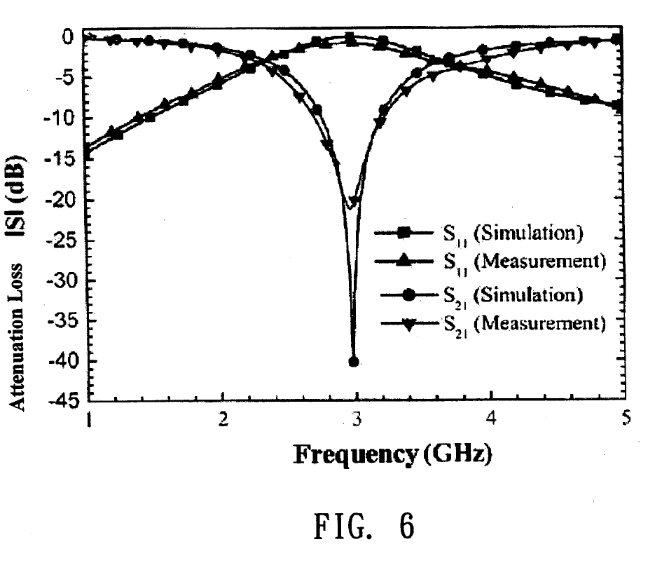

Please refer to FIG. 6. The defected structure of the present invention has W=4.75 mm, H=5.5 mm, Wc=0.25 mm, Wg=0.25 mm, and Hg=0.5 mm for S parameters in the full-wave simulation. According to FIG. 6, attenuation loss varies with frequency. In the present invention, S₁₁ is defined as return loss, and S₂₁ is defined as insertion loss.

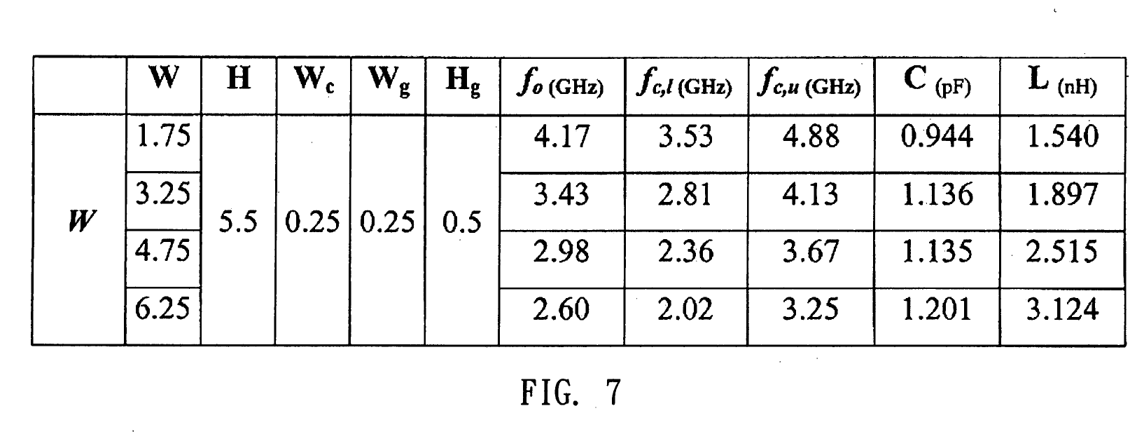

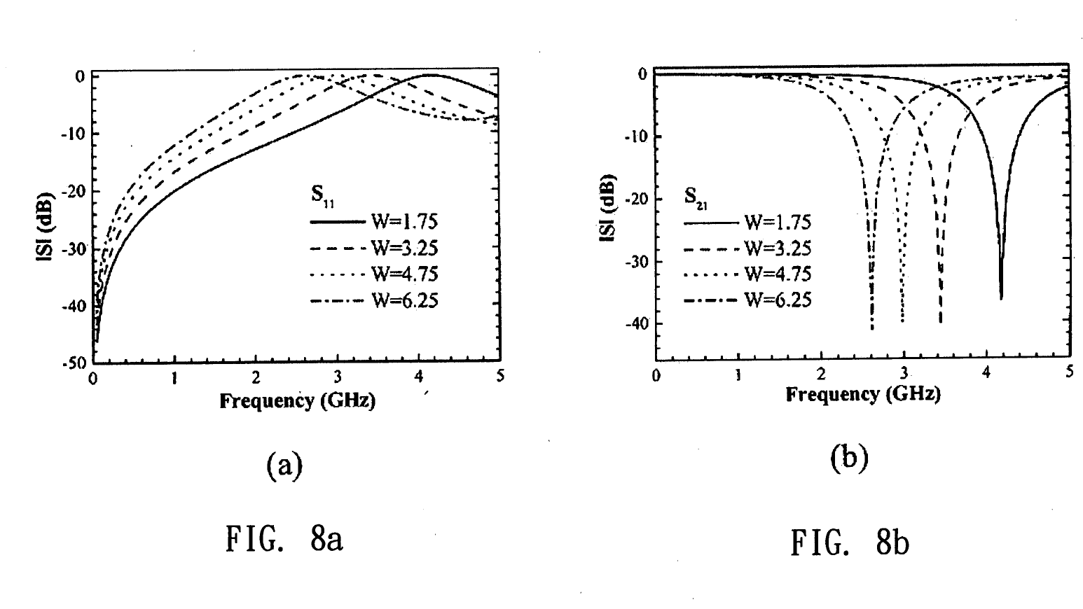

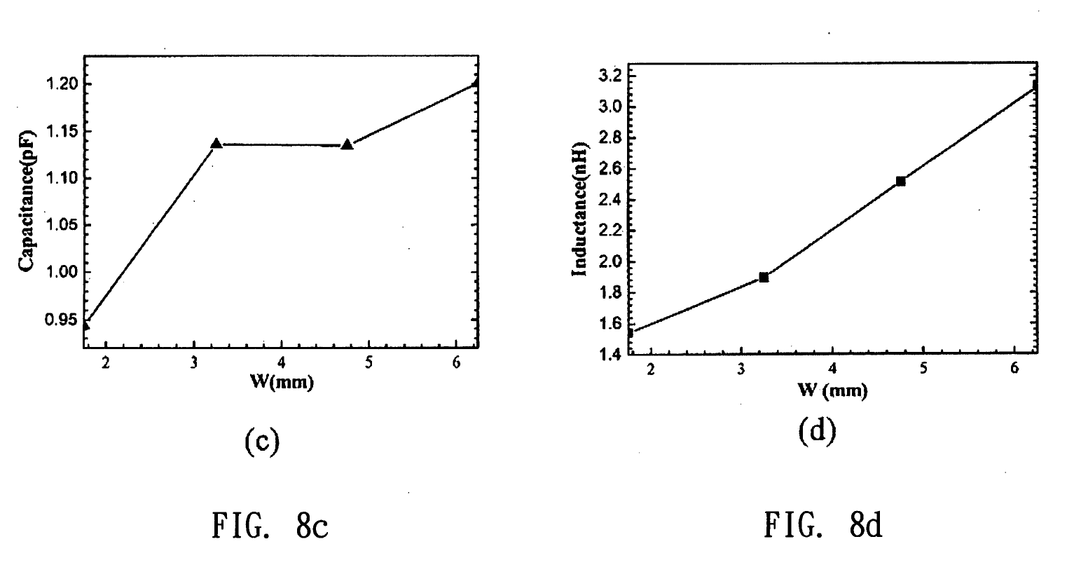

FIG. 7 shows the parameters of the total width change (W). FIGS. 8a, 8b, 8c, and 8d show the total width change (W) versus (a) S₁₁ full-wave simulation, (b) S₂₁ full-wave simulation, (c) capacitance, and (d) inductance, respectively. According to FIGS. 8a to 8d, while the total width (W) is increased, the resonant frequency (f₀) is decreased, the equivalent inductance (L) is obviously increased (approximately double number), and the equivalent capacitance (C) is obviously increased. Besides, the total width change (W) also obviously changes leaky-wave frequency, and stopband center frequency.

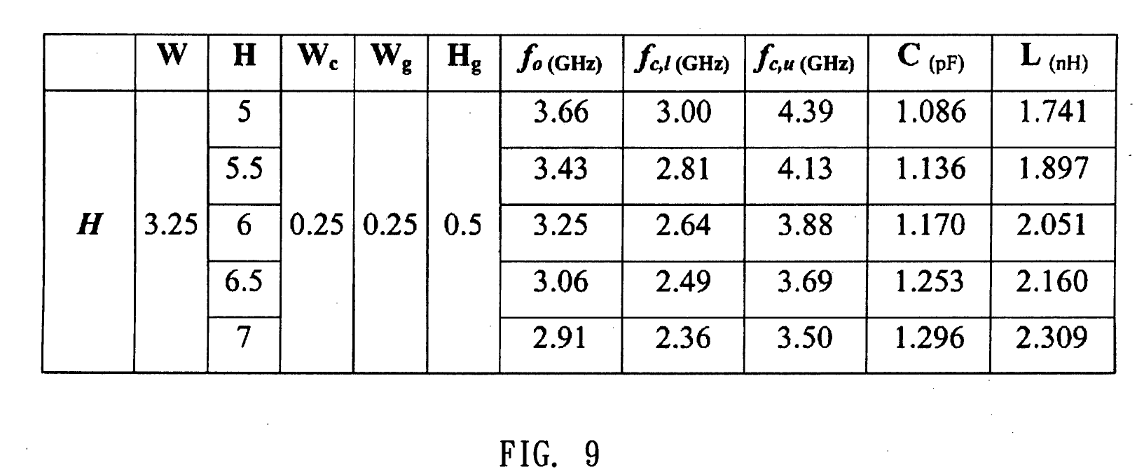

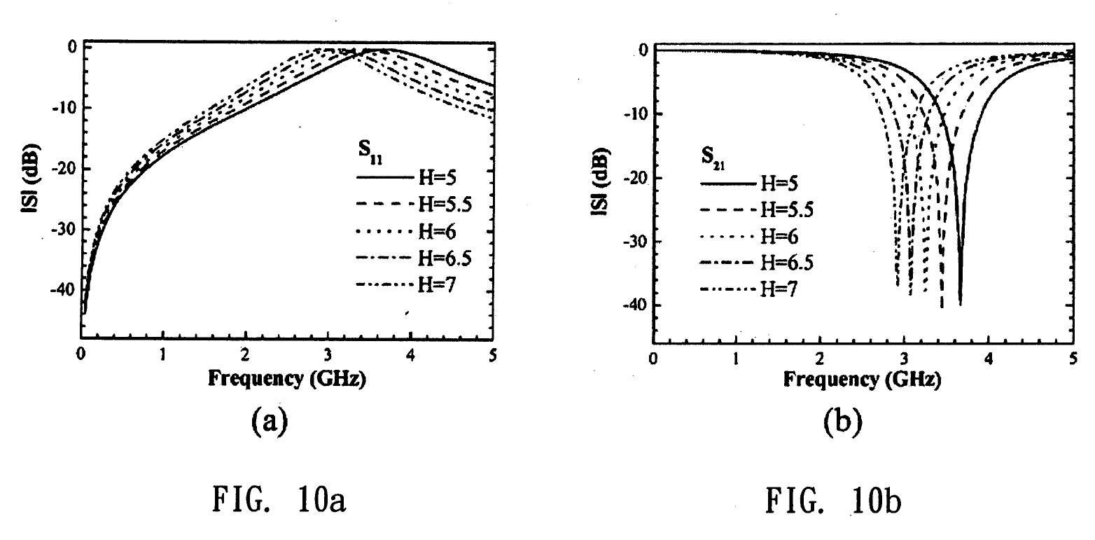

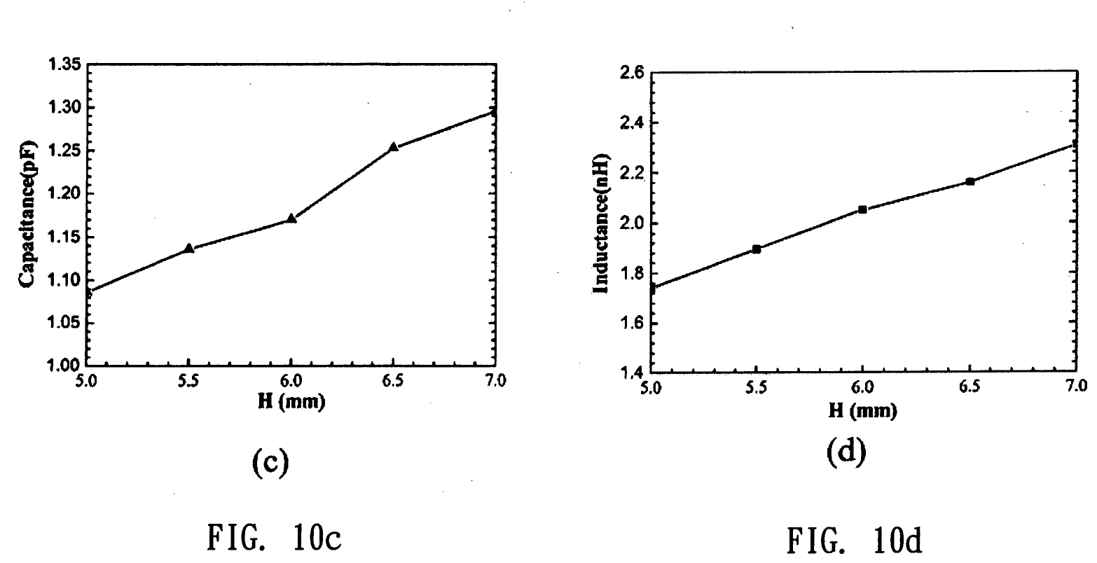

FIG. 9 shows the parameters of the total height change (H). FIGS. 10a, 10b, 10c, and 10d show the total height change (H) versus (a) S₁₁ full-wave simulation, (b) S₂₁ full-wave simulation, (c) capacitance, and (d) inductance, respectively. According to FIGS. 10a to 10d, while the total height (H) is increased, the resonant frequency (f₀) is decreased, but the equivalent inductance (L) and the equivalent capacitance (C) are all obviously increased. Besides, the total height change (H) also obviously changes leaky-wave frequency, and stopband center frequency.

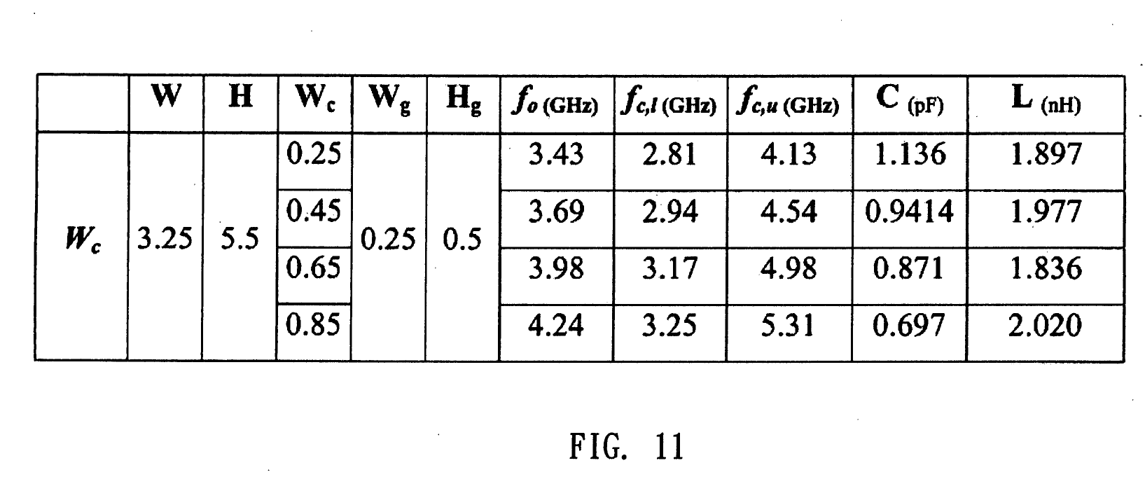

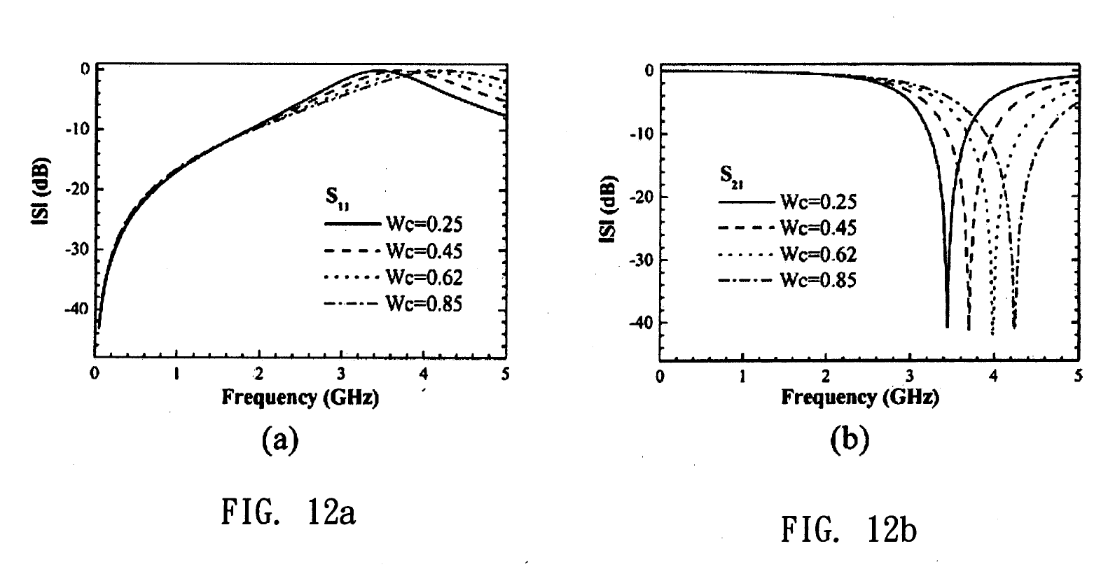

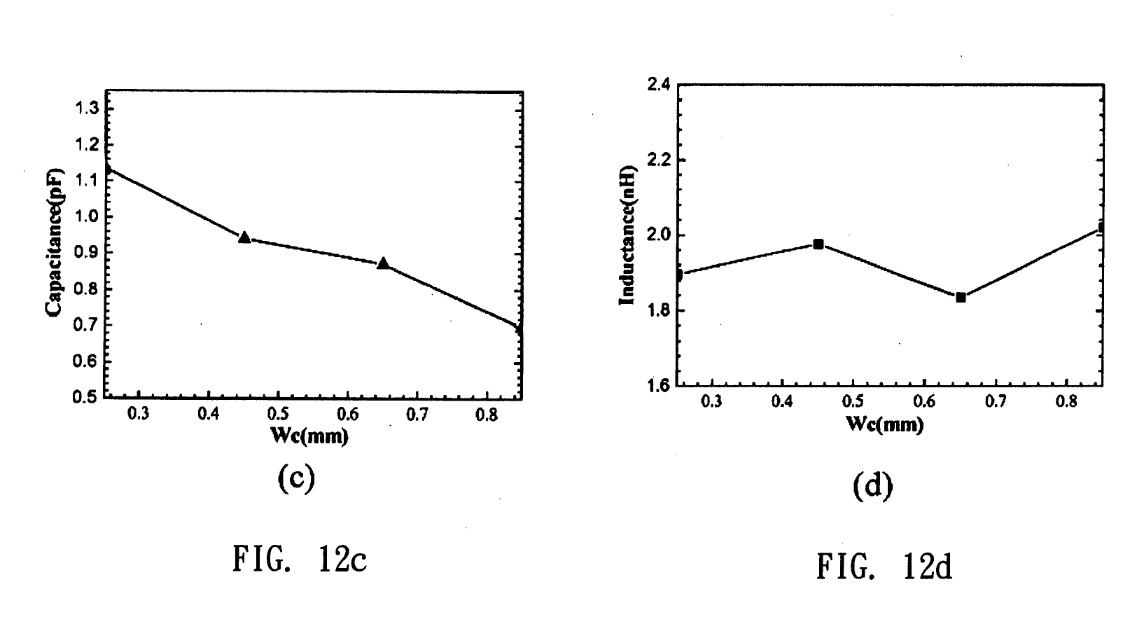

FIG. 11 shows the parameters of the width change (Wc) of the middle guide channel. FIGS. 12a, 12b, 12c, and 12d show the width change (Wc) of the middle guide channel versus (a) S₁₁ full-wave simulation, (b) S₂₁ full-wave simulation, (c) capacitance, and (d) inductance, respectively. According to FIGS. 12a to 12d, while the width (Wc) is increased, the resonant frequency (f₀) is increased, the equivalent inductance (L) is increased with little change, and the equivalent capacitance (C) is increased with an obvious change. Besides, the width change (Wc) also obviously changes leaky-wave frequency and stopband center frequency.

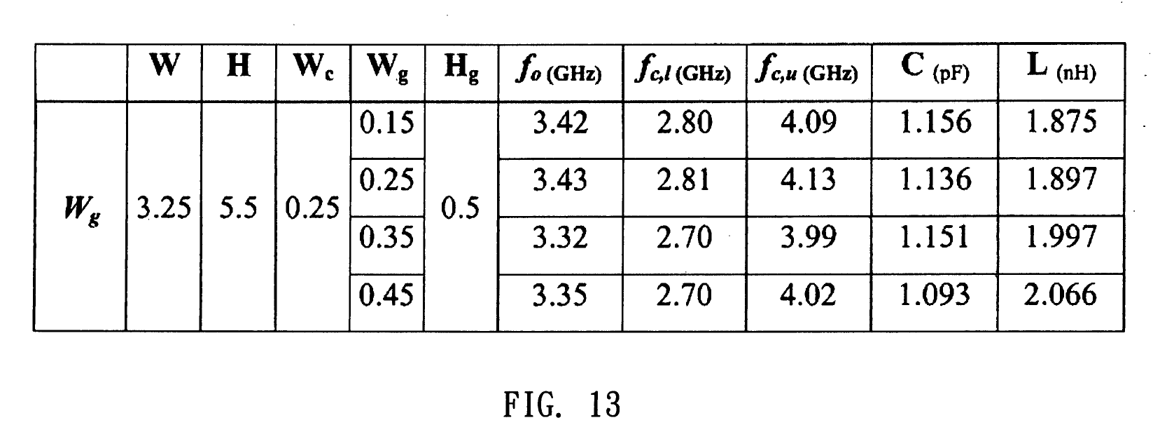

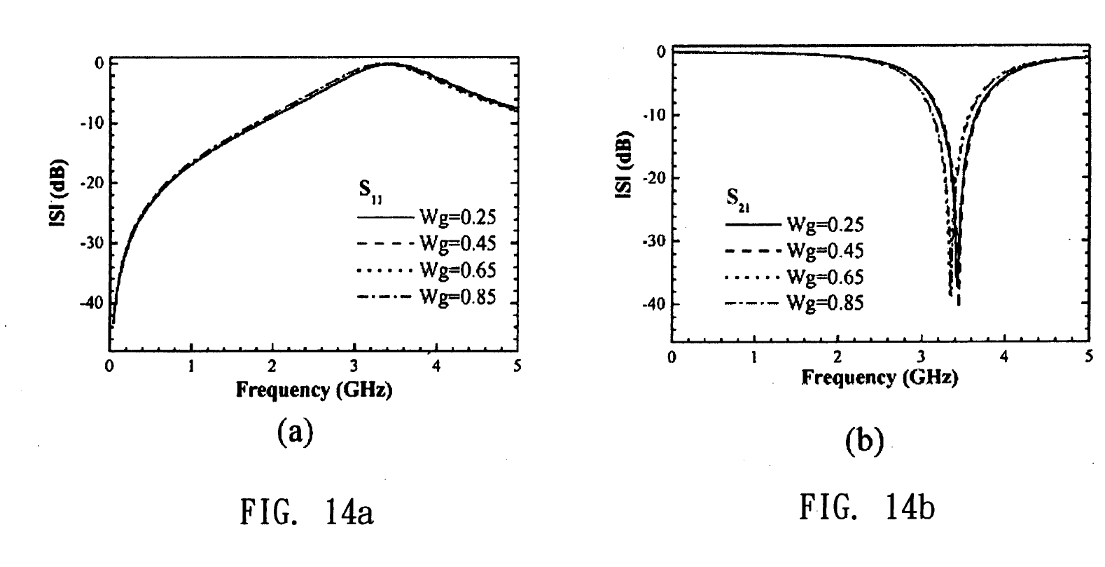

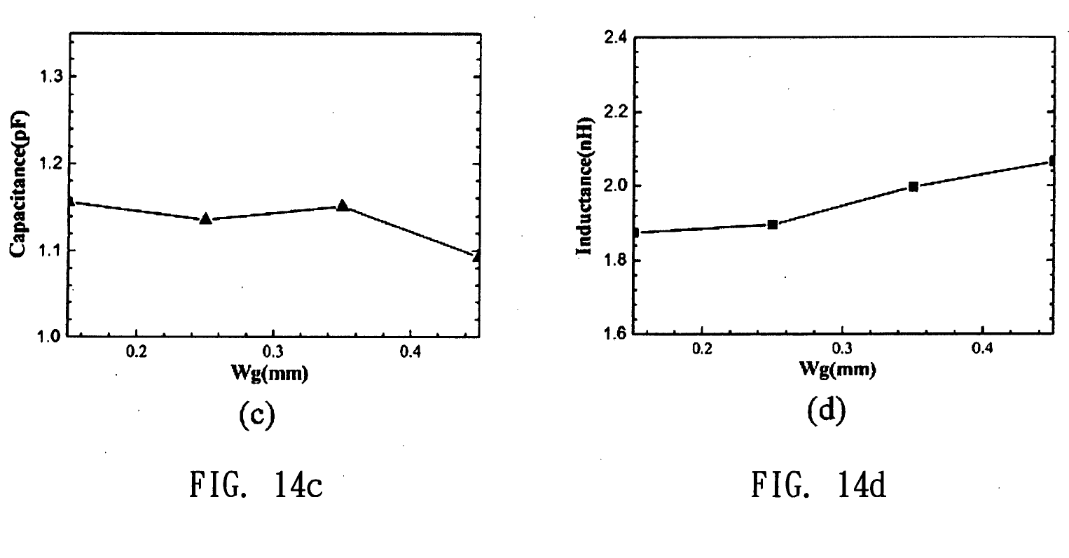

FIG. 13 shows the parameters of the width change (Wg) of the guide channel. FIGS. 14a, 14b, 14c, and 14d show the width change (Wg) of the guide channel versus (a) S₁₁ full-wave simulation, (b) S₂₁ full-wave simulation, (c) capacitance, and (d) inductance, respectively. According to FIGS. 14a to 14d, while the width (Wg) is increased, the resonant frequency (f₀) has an unobvious change, and the equivalent inductance (L) and the equivalent capacitance (C) have little change. Besides, the width change (Wg) only little changes leaky-wave frequency and stopband center frequency.

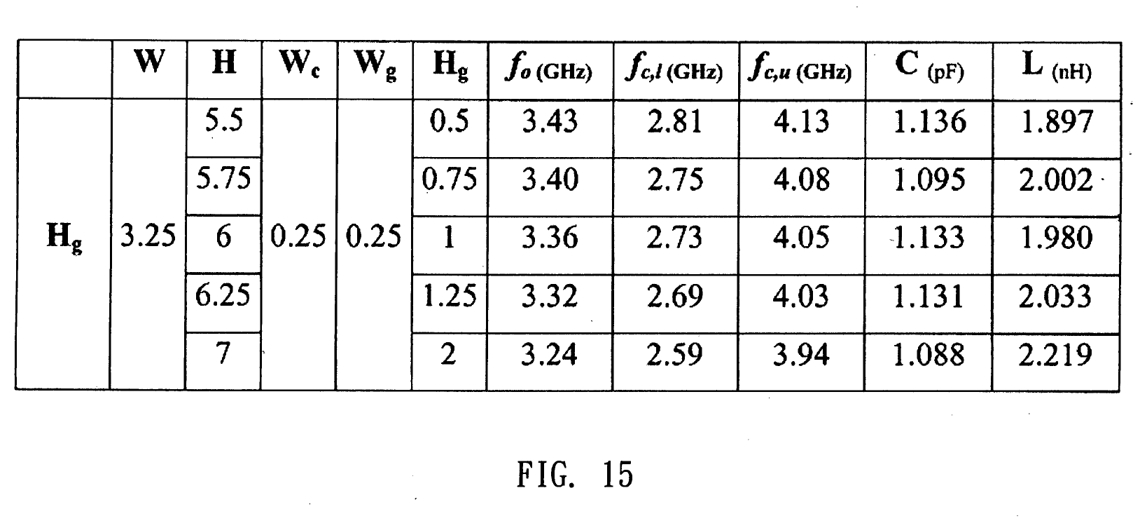

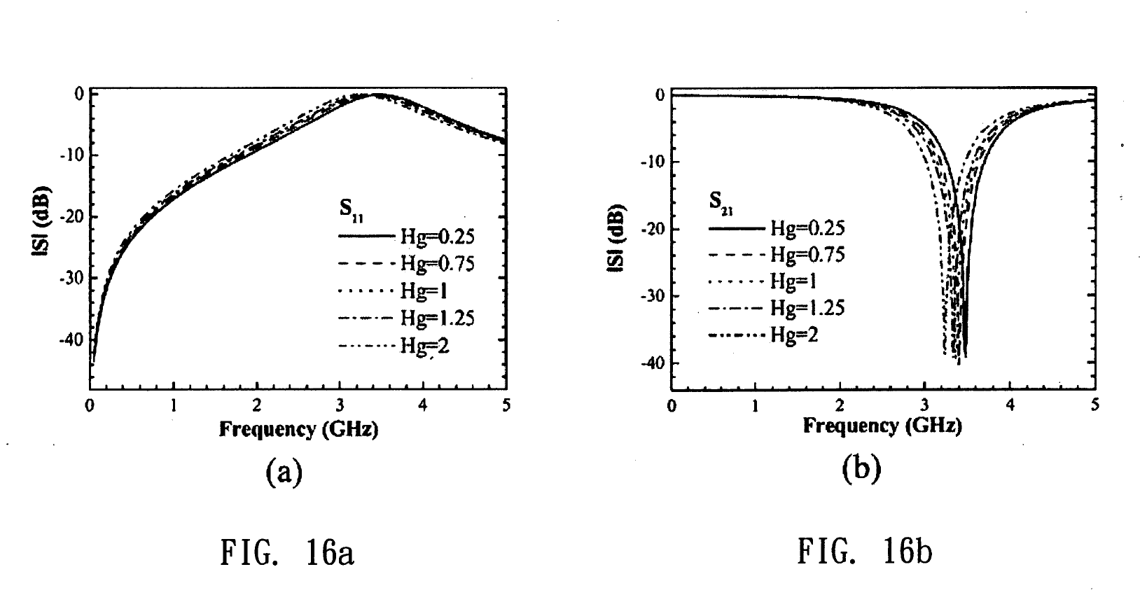

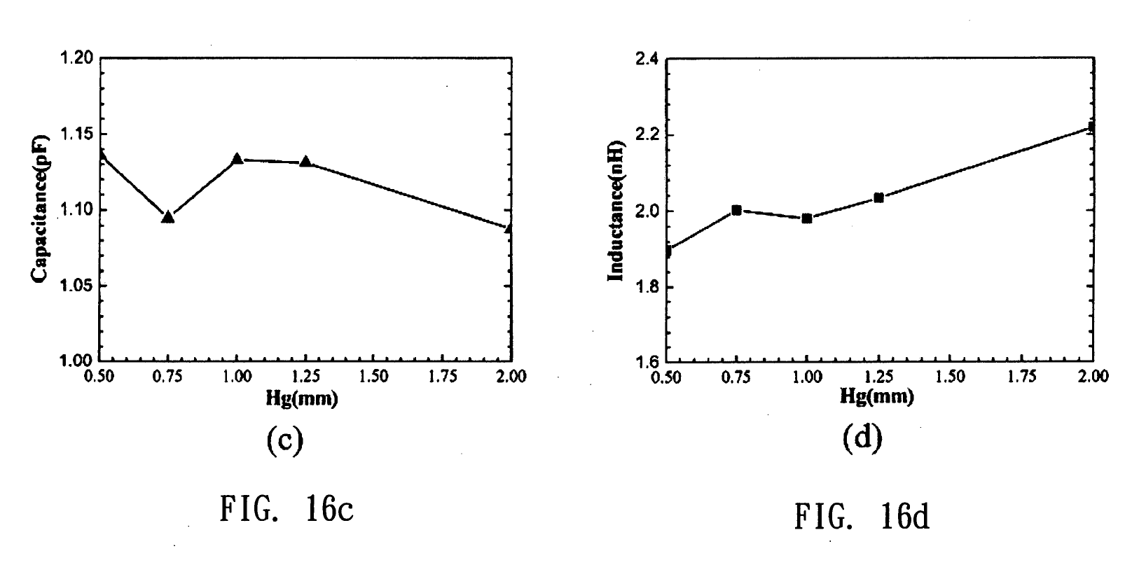

FIG. 15 shows the parameters of the height change (Hg). FIGS. 16a, 16b, 16c, and 16d show the height change (Hg) versus (a) S₁₁ full-wave simulation, (b) S₂₁ full-wave simulation, (c) capacitance, and (d) inductance, respectively. According to FIGS. 16a to 16d, while the height is increased, the resonant frequency (f₀) is decreased with little change, the equivalent inductance (L) is small increased, and the equivalent capacitance (C) is small decreased. Besides, the height change (Hg) also changes leaky-wave frequency and stopband center frequency.

In total, by adjusting the total width (W) and the total height (H) of the defected structure, the widths (Wg and Wc) of the guide channel (21), and the height (Hg) of the connection channel (22), it can change the resonant frequency, capacitance, inductance, leaky-wave frequency, and stopband center frequency of the whole coplanar waveguides. Therefore, the size of each part can be flexibly adjusted while designing the defected ground structure for coplanar waveguides.

According to above description, the present invention is to provide the defected ground structure for coplanar waveguides. Each defected structure includes at least two parallel guide channels (21). One of the guide channels is connected with the gap (G) of the coplanar waveguide, and each guide channel (21) is connected with other through a connection channel (22). Therefore, the structure for coplanar waveguides itself has a resonant characteristic. More, it forms a parallel equivalent circuit with multiple capacitors and inductors. In the same impedance, the present invention can efficiently reduce the area of the defected structure. Further, it can obtain a passband-stopband characteristic, a leaky-wave characteristic, and a slow-wave characteristic. By adjusting the total width (W) and the total height (H) of the defected structure, the widths (Wg and Wc) of the guide channel (21), and the height (Hg) of the connection channel (22), it can change the resonant frequency, capacitance, inductance, leaky-wave frequency, and stopband center frequency of the whole coplanar waveguides as well as enhance flexibility of adjustment.

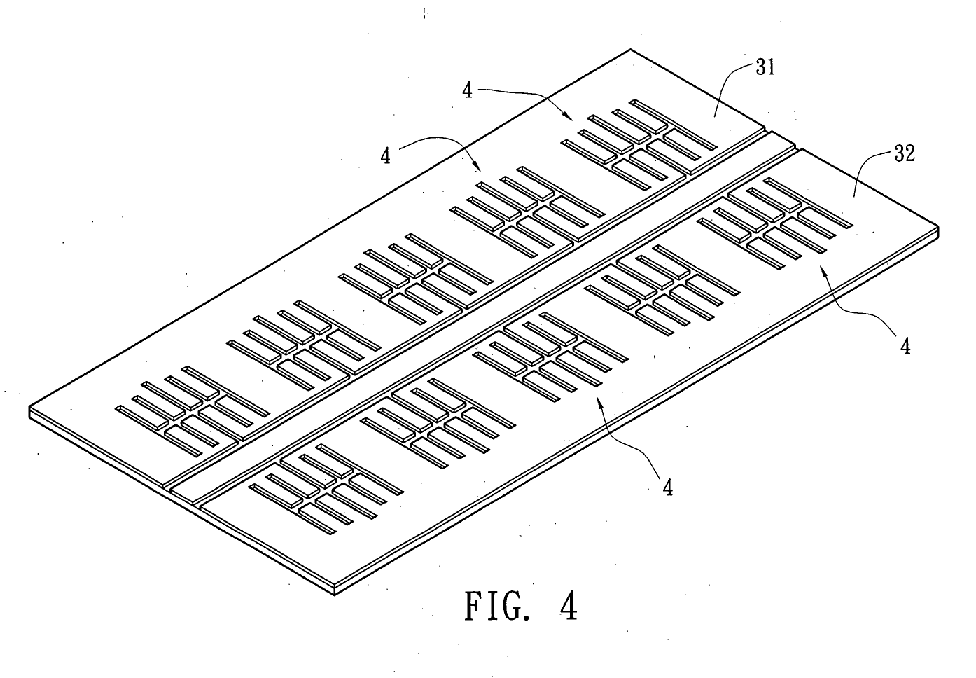

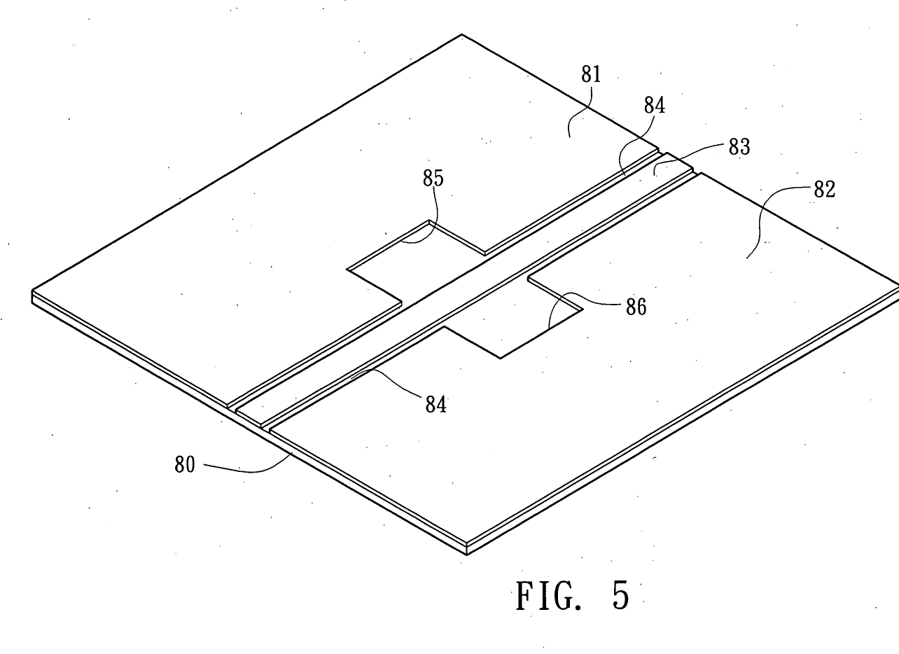

There are many examples showing the details in the present invention. The differences among the examples are only in the details. Please refer to FIG. 4, and this is the second preferred embodiment of the present invention. There are several defected structures (4) with the periodical arrangement on each ground plane (31 and 32). The design of the periodical arrangement can obtain the effects of equivalent series circuit for each defected structure.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof.

What is claimed is:

1. A defected ground structure for coplanar waveguides, comprising;
two ground planes; and
one wire positioning between two ground planes;
wherein a gap individually formed between each ground plane and the wire;
wherein each ground plane being symmetrical to the other having at least one defected structure;
wherein each defected structure having at least two parallel guide channels;
wherein one of the guide channels connecting with the gap; and
wherein each guide channel connecting with other through a connection channel.

2. The defected structure as claimed in claim 1, wherein each ground plane has multiple defected structures, and each structure has a periodical arrangement.

3. The defected structure as claimed in claim 1, wherein the connection channel is positioned in the middle section of each guide channel.

4. The defected structure as claimed in claim 1, wherein the guide channel vertically intersects with the gap.

5. The defected structure as claimed in claim 1, wherein the connection channel vertically intersects with each guide channel.
